(19) United States
(12) Patent Application Publication
(10) Pub. No.: US 2006/0074673 A1
(43) Pub. Date: Apr. 6, 2006

(54) Pronunciation synthesis system and method of the same

(75) Inventors: Chaucer Chiu, Taipei (TW); Max Ma, Shanghai (CN)

Correspondence Address: EITAN, PEARL, LATZER & COHEN ZEDEK LLP, 10 ROCKEFELLER PLAZA, SUITE 1001, NEW YORK, NY, 10020, US

(73) Assignee: INVENTEC CORPORATION

(21) Appl. No.: 11/016,932

(22) Filed: Dec. 21, 2004

(30) Foreign Application Priority Data
Oct. 5, 2004 (TW) 093130081

(51) Int. Cl. G10L 13/08

(52) U.S. Cl. 704/260

(57) ABSTRACT

A pronunciation synthesis system and method. The pronunciation synthesis system may pre-analyze a word to decompose the word into word root(s) and/or affix(es). The pronunciation synthesis system may include at least an analyzing module, a searching module, a pronunciation module, and a synthesizing module. The pronunciation synthesis system may be provided to search for phonetic waveform data that corresponds to the word root or affix so as to automatically synthesize the phonetic waveform data for the word.

### RELATED APPLICATION DATA

The present application claims priority from prior Taiwanese application 093130081, filed Oct. 5, 2004, incorporated herein by reference.

1. Field of the Invention

The present invention relates to pronunciation synthesis systems and methods of the same, and more particularly, to a pronunciation synthesis system and method of the same which can automatically synthesize pronunciation data of words.

2. Description of the Prior Art

The electronic dictionary has become an indispensable tool for many people learning foreign languages, due to its compact size, large storage capacity, human pronunciation and unlimited data expansion.

Pronunciation functions of most of present electronic dictionaries are carried out by two manners. One of the manners is to prerecord pronunciations of words. The prerecorded pronunciations are converted into voice files and stored in the dictionary. Each voice file is linked to the corresponding word for providing correct pronunciation of each word selected by a user. However, this method cannot provide corresponding pronunciations for user-built words since the pronunciation data cannot be updated at the same time. The other manner is the electronic dictionary automatically synthesizes pronunciations via a Text-To-Speech (TSS) engine. However, the pronunciations synthesized by TTS engine are unnatural and thus unsatisfactory.

Therefore, there is a need for a technique that automatically synthesizes pronunciations of words with improved pronunciations.

### SUMMARY OF THE INVENTION

In order to solve the defects of the prior art, a primary objective of the present invention is to provide a pronunciation synthesis system and method of the same that can automatically analyze the structure of a word for synthesizing a corresponding pronunciation data of the word.

In order to achieve the above objective, the present invention provides a pronunciation synthesis system and method. The system comprises: (1) an analyzing module for analyzing the structure of a word and decomposing the word according to the analysis to obtain a combination of word root(s) and/or affix(es);. (2) a searching module for searching a database for related word data to obtain phonetic waveforms corresponding to the decomposed word root(s) and/or the affix(es); (3) a segmenting module using syllable as the unit for segmenting the searched word data while referring to the word root(s) and/or affix(es) decomposed by the analyzing module so as to obtain corresponding pronunciation data of the word root(s) and/or the affix(es); and (4) a synthesizing module for arranging and combining the data of phonetic waveforms obtained from the segmenting module so as to form one by one corresponding relations with the combination of the word root(s) and/or the affix(es) that constitute the word for synthesizing the pronunciation data of the word.

As described above, the foregoing system is adapted to be used in an electronic dictionary. The analyzing module decomposes the word into a combination of multiple word root(s) and/or affix(es) according to a word construction rule. The searching module searches for all word data containing the word root(s) or the affix(es) from the database according to the word root(s) and/or the affix(es). The searching module further comprises a sifting unit. The sifting module compares all the related word data searched by the searching module with the word root(s) and/or affix(es) decomposed by the analyzing module, so as to sift out a most preferred word data for subsequent segmenting process by the segmenting module.

The pronunciation synthesis method of the present invention comprises: (1) providing an analyzing module for analyzing the structure of a word and decomposing the word according to the analysis to obtain a combination of word root(s) and/or affix(es); (2) providing a searching module for searching a database for related word data to obtain phonetic waveforms corresponding to the decomposed word root(s) and/or the affix(es); (3) providing a segmenting module using syllable as the unit for segmenting the searched word data while referring to the word root(s) and/or affix(es) decomposed by the analyzing module so as to obtain pronunciation data corresponding to the word root(s) and/or the affix(es); and (4) providing a synthesizing module for arranging and combining the data of phonetic waveforms obtained from the segmenting module so as to form one by one corresponding relations with the combination of the word root(s) and/or the affix(es) that constitute the word for synthesizing the pronunciation data of the word.

In foregoing descriptions, every data produced in each step of the method of the present invention is saved in a database. The database further saves a plurality of word data and the respective phonetic waveforms. In step (1), the analyzing module decomposes the word into a combination of multiple word root(s) and/or affix(es) according to the word construction rule. In step (2), the searching module searches all word data comprising those word root(s) or those affix(es). Moreover, in step (2), a sifting module further compares all word data searched by the searching module with the word root(s) and/or affix(es) decomposed by the analyzing module so as to filter out a most preferred word data for subsequent process by the segmenting module. If there is a word data of the database completely identical with the word root(s) and/or the affix(es), this word data is the preferred one. If there are a plurality of candidates of word data, it would selects a word data, which has the same or the least difference in construction with the analyzed word root(s) and/or affix(es), as the preferred word data.

Therefore, the pronunciation synthesis system and method of the same of the present invention can decompose a word into a combination of multiple word root(s) and affix(es) and search for the preferred phonetic waveform data corresponding to the word root(s) and/or affix(es) such that pronunciation data of the word can be automatically synthesized to obtain an improved pronunciation effect.

### BRIEF DESCRIPTION OF THE DRAWINGS

FIG. 1 is a block diagram showing the basic structure according to the pronunciation synthesis system of the present invention; and

FIG. 2 is a flow chart showing the operating steps of the pronunciation synthesis method of the present invention.

### DETAILED DESCRIPTION OF THE PREFFERED EMBODIMENT

The descriptions below of specific embodiments are to illustrate the present invention. Others skilled in the art can easily understand other advantages and features of the present invention from contents disclosed in this specification. The present invention can be carried out or applied through different embodiments.

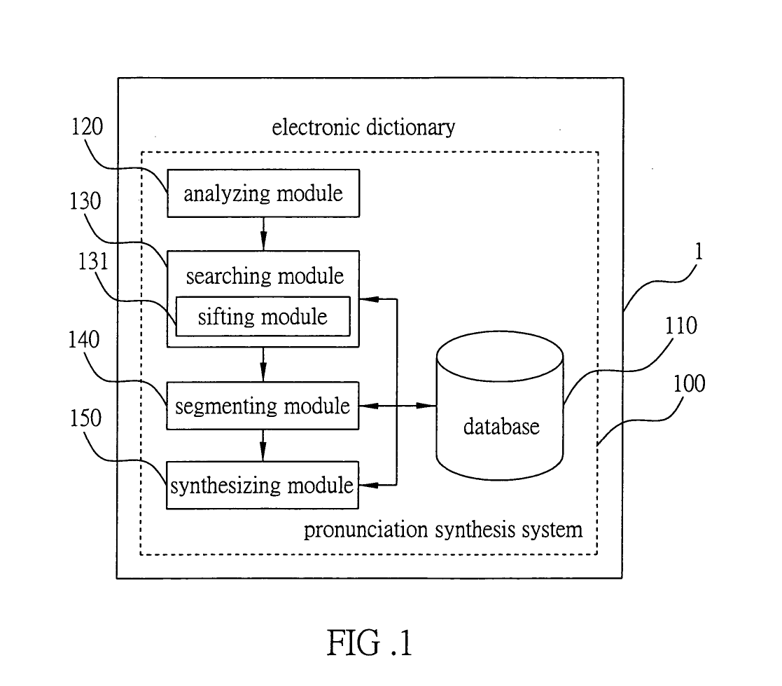

FIG. 1 is a block diagram showing the pronunciation synthesis system of the present invention that can be suitably used in an electronic dictionary. As shown, the pronunciation synthesis system of the present invention is provided in an electronic dictionary for automatically synthesizing pronunciation data of a word. The pronunciation synthesis system 100 includes a database 110, an analyzing module 120, a searching module 130, a segmenting module 140 and a synthesizing module 150, wherein the searching module 130 further includes a sifting unit 131.

The database 110 is provided for saving a plurality of word data and the corresponding phonetic waveform data. In this embodiment, the database 110 is divided into a word database and a pronunciation database (both not shown), wherein the word database saves relevant data for each word in the electronic dictionary 1, such as phonetic symbols, lexical categories, characters, illustrations etc. Users may expand and update the database for new information. The pronunciation database saves phonetic waveform data of words and connects to the word database. Each pronunciation data of the pronunciation database is corresponding to a word of the word database.

The analyzing module 120 is provided to analyze the structures of words. The analyzed word is decomposed according to the analyzing result such that the word is converted into a collocation of word roots and/or affixes. Most of the English words are derivations constituted by word roots and affixes (prefixes and/or suffixes). For example, a word constituted by “a word root+a suffix” is for example: the word “painter” constituted by paint+-er; a word constituted by “a prefix+a word root” is for example: the word “intervene” constituted by inter- and -vene; a word constituted by “a word root+a word root” is for example: the word “telescope” constituted by tele and scope; a word constituted by “a prefix+a word root+a suffix” is for example: the word “inaudible” constituted by in-, aud and -ible; and etc. In this embodiment, the analyzing module applies foregoing construction rules to dividing a word into a collocation of word root(s) and/or affix(es). For example, the word “methodology” may be divided into a word root “method” and a suffix “ology”.

The searching module 130 searches the database 110 for corresponding phonetic waveform data of each word root and/or affix according to the analysis of the analyzing module 120. The searching module 130 further comprises a sifting module 131. The sifting module 131 compares all word data searched by the searching module 130 with the word root(s) and/or affix(es) decomposed by the analyzing module so as to select a preferred word data to provide to the segmenting module 140 for further processing (as would be described as follows). The selection rule for selecting a preferred word data is that if there is a word data stored in the database 110 completely matching the word root or affix (usually the word root), the word data is the preferred one; if there are a plurality of candidates (usually the affixes) of word data, it would select a word data, which has the same construction or the fewest difference with the analyzed word root or affix, as the preferred word data.

In this embodiment, the searching module 130 firstly searches the database 110 for all words comprising the word root “method” obtained by decomposing by the analyzing module, such as “method”, “methodic”, “Methodist”, “unmethodical” and etc. Then, the sifting unit 131 compares the searched word data with the word root “method”. In the database 110, the word “method” that completely matches the decomposed word root “method” is found, thus the searched word “method” would be considered as the preferred word data corresponding to the word root.

Next, the searching module 130 continuously searches the database 110 for word data comprising the affix “ology”, such as “technology”, “sociology”, “biology”, and etc. Then, the sifting unit 131 compares those searched word data one by one with the affix “ology”. As a result, a word data completely identical with the affix “ology” is not found, the sifting unit 131 would analyze where the part “ology” is in the words. Since “ology” is the “suffix” of the word “methodology”, the sifting unit 131 sifts out all word data comprising the suffix “ology” from the database 110. The sifting unit 131 compares the sifted word data with the suffix “ology” for obtaining a preferred word data. For example, a word after subtracting the affix “ology” has the fewest letters is selected. After the comparison, since the word “biology” is most similar with the suffix “ology”, the word “biology” would be selected as the preferred word data.

The segmenting module 140 uses syllable as the unit for segmenting the selected word data while at the same time referring to the word root(s) and/or affixes decomposed by the analyzing module 120 so as to obtain pronunciation data corresponding to the word root(s) and/or affix(es). In this embodiment, results of the searching module 130 is the word “method” corresponding to the decomposed root “method” and the word “biology” corresponding to the decomposed affix “ology”. Since the word “method” is completely identical with the word root, the corresponding “phonetic waveform 1” (not shown) of the word can be directly used. The segmenting module 140 uses syllable (vowels or consonants) as a unit while referring the affix “ology” to segment the phonetic waveform of the word “biology”. The phonetic waveform is divided at the second vowel “o”, and the phonetic waveform data of the word segment after the second vowel is intercepted and stored as “phonetic waveform 2”, in other words, the “phonetic waveform 2 (not shown)” corresponds to the affix “ology”.

The synthesizing module 150 is provided to arrange and combine the phonetic waveform data processed by the segmenting module 140, forming one-by-one relations with the collocation that composed of the word root(s) and/or the affix(es) so as to synthesis the pronunciation data of the word. In this embodiment, the synthesizing module 150 respectively arranges the “phonetic waveform 1” data and the “phonetic waveform 2” data, both processed by the segmenting module 140″, according to positional relationships of the corresponding word root(s) and/or the affix(es), that is, “method” (phonetic waveform 1)+“ology” (phonetic waveform 2) combines to form the sound synthesis of the word “methodology”.

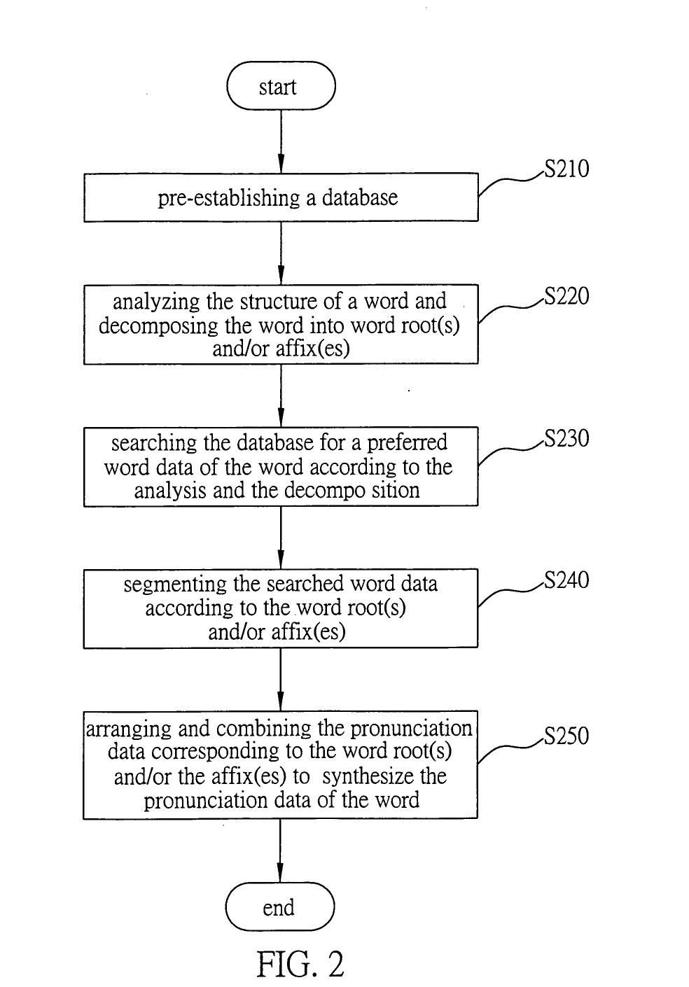

FIG. 2 is a flow chart showing the operating method of the pronunciation synthesis system of the present invention. The pronunciation synthesis method of the present invention is adapted to be used in an electronic dictionary. As shown, step S210 is firstly performed. A database 110 is pre-established for storing all relative interpreting data and corresponding phonetic waveform data of all words. Next, step S220 is performed.

In step S220, the analyzing module 120 analyzes the structure of a word “methodology” and decomposing the word into a word root “method” and a suffix “ology” according to the analysis. Next, step S230 is performed.

In step S230, the searching module 130 searches the database 110 for word data relevant to the word root and the affix decomposed by the analyzing module, so as to obtain corresponding phonetic waveform data. In this embodiment, the searching module 130 searches the database 110 for all word data comprising the word root “method”, the word data such as “method”, “methodic”, “methodist”, “unmethodical” and etc.; the searching module 130 also searches the database 110 for all word data comprising the affix “ology”, the word data such as “technology”, “sociology”, “biology” and etc; then, the sifting unit 131 compares those searched word data one by one. As a result, the preferred word data “method” for the word root “method” and the preferred word data “biology” for the affix “ology” are obtained. Next, step S240 is performed.

In step S240, the segmenting module 140 uses syllable as a unit while referring the word root and the affix to divide the preferred word data, searched by the searching module 130, so as to obtain the “phonetic waveform 1” data of the word root “method” and the “phonetic waveform 2” data of the affix “ology”. Next, step S240 is performed.

In step 250, the synthesizing module 150 arranges and combines the “phonetic waveform 1” data and the “phonetic waveform 2” data, both processed by the segmenting module 140, in the order of “method” (phonetic waveform 1)+“ology” (phonetic waveform 2) according to the sequence of the corresponding word root “method” and the affix “ology”, thereby forming a pronunciation synthesis of the word “methodology”.

In the foregoing description, the pronunciation synthesis system and method of the same according to the present invention is suitable for use in an electronic dictionary. The method comprises pre-analyzing a word for recognizing word root(s) and/or affix(es) composing the word; searching a database of the electronic dictionary for preferred word data for each of the word root(s) and/or the affix(es); and arranging and combining all the searched pronunciation data for synthesizing the pronunciation data of the word.

The embodiments above are set forth to illustrate various aspects of the present invention, and should not be construed as to limit the scope of the present invention in any way. It will be apparent fort those skilled in the art that various changes and modifications can be made, and equivalents employed, without departing from the scope of the claims.

What is claimed is:

1. A pronunciation synthesis system, comprising:
a database for storing a plurality of word data and phonetic waveform data corresponding to the pronunciations of the word data;
an analyzing module for analyzing the structure of a word and decomposing the word into smaller units, the smaller units being at least one selected from the group consisting of a word root and an affix;
a searching module for searching in the database for word data that are relevant to the decomposed smaller units of the word so as to retrieve the phonetic waveform data of the searched word data;
a segmenting module using syllable as a segmenting unit while referring to the decomposed smaller units of the word to segment the phonetic waveform data retrieved by the searching module in order to obtain pronunciation data that respectively correspond to the pronunciation of the smaller units; and
a synthesizing module for arranging the pronunciation data so that each pronunciation data correspond in place with the location of each of the smaller units of the word to form a pronunciation synthesis of the word.

2. The pronunciation synthesis system as claimed in claim 1, wherein the system is suitable for use in an electronic dictionary.

3. The pronunciation synthesis system as claimed in claim 1, wherein the analyzing module decomposes the word into smaller units according to a word construction rule.

4. The pronunciation synthesis system as claimed in claim 3, wherein the affix comprises prefixes and suffixes.

5. The pronunciation synthesis system as claimed in claim 1, wherein the searching module searches the database for all word data comprising the word root or the affix according to the decomposed word root or affix.

6. The pronunciation synthesis system as claimed in claim 1, wherein the searching module further comprises a sifting unit for comparing all word data searched by the searching module with the smaller units decomposed by the analyzing module so as to select a preferred word data to provide to the segmenting module for further processing.

7. The pronunciation synthesis system as claimed in claim 6, wherein if a word data in the database is determined to match exactly with the one of the smaller units, the word data is the preferred word data for that unit.

8. The pronunciation synthesis system as claimed in claim 6, wherein if a plurality of word data candidates are found, the word data having the fewest letters after subtracting the corresponding smaller unit is the preferred word data for that unit.

9. A pronunciation synthesis method, suitable for use in a pronunciation synthesis system, the method comprising:
(1) providing an analyzing module for analyzing the structure of a word according to a word construction rule and decomposing the word smaller units, the smaller units being at least one selected from the group consisting of a word root and an affix;
(2) providing a searching module for searching a database for word data which correspond to the decomposed smaller units of the word so as to retrieve the phonetic waveform data of the searched word data;
(3) providing a segmenting module using syllable as a segmenting unit while referring to the decomposed smaller units of the word to segment the phonetic waveform data retrieved by the searching module in order to obtain pronunciation data that respectively correspond to the pronunciation of the smaller units; and
(4) providing a synthesizing module for arranging the pronunciation data so that each pronunciation data correspond in place with the location of each of the smaller units within the word to form a pronunciation synthesis of the word.

10. The pronunciation synthesis method as claimed in claim 9, wherein the pronunciation synthesis system is suitable for use in an electronic dictionary.

11. The pronunciation synthesis method as claimed in claim 9, wherein the data produced in each step of the method is stored in a database.

12. The pronunciation synthesis method as claimed in claim 11, wherein the database is further provided to store a plurality of word data and phonetic waveform data corresponding to the pronunciations of the word data.

13. The pronunciation synthesis method as claimed in claim 9, wherein step (1) further comprises analyzing the structure of the word by the analyzing module according to the word construction rule to decompose the word into a word root and at lease one affix.

14. The pronunciation synthesis method as claimed in claim 9, wherein step (2) further comprises the searching module searching the database for all word data comprising the word root and the affix.

15. The pronunciation synthesis method as claimed in claim 14, wherein step (2) further comprises providing a sifting module to compare all word data searched by the searching module with the word root and the affix decomposed by the analyzing module, so as to select a preferred word data to provide to the segmenting module for further processing.

16. The pronunciation synthesis method as claimed in claim 15, wherein in step (2), if the comparison result of the sifting module is that a word data in the database completely matches with the decomposed word root or the affix, the word data is the preferred word data for that word root or affix.

17. The pronunciation synthesis method as claimed in claim 15, wherein in step (2), if a plurality of word data candidates are found, the sifting module determines that, among the plurality of word data, a word data having the same letter construction or fewest difference with the decomposed word root or affix is the preferred word data.
